(19) United States
(12) Patent Application Publication
(10) Pub. No.: US 2017/0144534 A1
(43) Pub. Date: May 25, 2017

(54) CONTAINER COMPRISING A TECHNICAL MODULE RESTING ON THE INNER WALL OF THE CONTAINER

(71) Applicant: PLASTIC OMNIUM ADVANCED INNOVATION AND RESEARCH, Bruxelles (BE)

(72) Inventors: Franck DHAUSSY, Margny-Les-Compiegne (FR); Gwereg PAOLINI, Le Plessis Brion (FR)

(73) Assignee: PLASTIC OMNIUM ADVANCED INNOVATION AND RESEARCH, Bruxelles (BE)

(21) Appl. No.: 15/323,826

(22) PCT Filed: Jul. 1, 2015
(86) PCT No.: PCT/FR2015/051807

§ 371 Date: Jan. 4, 2017

(30) Foreign Application Priority Data
Jul. 7, 2014 (FR) 1456546

(51) Int. Cl. B60K 15/03

(52) U.S. Cl. CPC B60K 15/03; B60K 2015/03447; B60K 2015/03467; B60K 2015/03427; B60K 2015/03217; B60K 2015/03243

(57) ABSTRACT

A container including an inner wall including an opening sealed by a plate of a technical module including at least one technical device, the sealing of the opening resulting from insertion of the plate into the opening in a main direction. The plate of the technical module includes a flange including a bearing surface, and the inner wall of the vessel includes a bearing directed towards the inside of the container, which acts as a seat for the flange, to block passage of the plate of the technical module through the opening towards outside of the container.

The present invention relates to the containers that are utilized in particular in the automobile industry. These containers comprise a multiplicity of ancillary technical devices for the purpose of controlling the distribution of the fluids contained in the container according to the needs of the vehicle. These fluids are preferably present in liquid form and may be fuel, but may also be liquids utilized by the engine emission control systems such as urea.

More specifically, the invention is concerned with the method of attachment of a technical module comprising a plurality of technical devices such as a pump, means of heating or reheating the liquid contained in the container, a temperature sensor, a concentration sensor or also a level sensor. For reasons of efficiency, it is often preferred to combine several devices in order to form a single technical module, which is introduced into the container in a single operation. This technical module is mounted on a plate which is attached to the wall of the container.

The manufacture of the containers may be undertaken in a traditional manner from a thermoplastic material, by vacuum molding of a parison, by injection, or also by the thermoforming of a plastic sheet.

Bearing in mind the limited resistance to heat of the technical devices described above, it is necessary to introduce them into the container after the cooling and the stabilization of the thermoplastic material forming the walls of the container.

The technical module is introduced into the container through an opening produced beforehand in the wall of the container, and the opening is sealed by the plate which is an integral part of the module.

In general, the module opens in part towards the outside of the container in order to permit easy access to the electrical connection elements. The form of the module is then adjusted in such a way as to seal the opening completely, so that it is possible to attach the technical module to the container using an annular threaded nut or closure claws embedded beforehand in the material of the wall of the container. An O-ring, positioned between two technical surfaces situated respectively on the wall of the container and on the technical module, makes it possible to ensure a seal between the module and the container under the effect of the clamping pressure exerted by the annular nut or by the closure claws.

The module may likewise be attached to the inner wall of the container using specific means, and the opening is then reclosed with a screwed cap forming a fluid-tight connection with the wall of the container.

However, these closure systems require the application of a large number of precision components, of which the assembly calls for the manual intervention of an operator.

An increase in the number and in the size of the technical devices that are attached to the module can also be noted. This leads to an increase in the size of the module and, at the same time, in the size of the opening through which the module is introduced into the container.

This results in the need to provide reinforcing elements around the opening such as to ensure the good geometrical stability of this part of the container where perfect sealing is sought between the module or the screwed cap and the wall of the container.

The invention has as its aim to propose an alternative system making it possible to simplify the operation of installing the technical module inside the container, and to reduce substantially the costs of mounting and assembly, to improve the sealing between the module and the container while allowing the introduction of large technical devices.

The container according to the invention comprises a wall including an opening sealed by a plate of a technical module including technical devices, the sealing of the opening resulting from the insertion of the plate into the opening in a main direction.

This container is characterized in that the plate of the technical module comprises a flange including a bearing surface, and in that the inner wall of the container includes a bearing directed towards the inside of the container, which acts as a seat for the flange, such as to block the passage of the plate of the technical module through the opening towards the outside of the container.

The mounting of the technical module thus takes place by a movement in the main direction from the inside of the container towards the outside of the container.

Preferably, the container is manufactured in two parts, or two half shells, which are assembled by welding. This embodiment thus allows the use of methods of manufacturing by injection, of which the profitability is much higher than that of the methods of manufacturing of the container in a single piece.

This mode of introduction also makes it possible to reduce the size of the opening solely to meet the needs generated by the passage of the means of exchange between the technical devices and the components of the vehicle situated outside the container. This results in much better sealing in the area of the opening.

By allowing the technical module to rest directly on the internal part of the wall of the container, the structural and geometrical behavior of the link between the container and the technical module are also improved without the need to increase the reinforcements in this zone of the container.

The container according to the invention may also comprise the following characterizing features, either individually or in combination:
Means of restraint are provided in order to prevent the plate from becoming disengaged from the opening, while at the same time allowing it to move radially in relation to the main direction.
The means of restraint are arranged inside the cavity of the container and include a restraining face intended to be brought into engagement with a restraining face of the flange opposite the bearing surface.
The means of restraint are formed by snap-fastening devices comprising a plurality of lugs, including claws on their radially internal face positioned on the wall of the container and extending in the main direction from the internal face of the wall of the container towards the inside of the container.
The means of restraint are formed by elements welded onto the internal face of the wall of the container.
The means of restraint are arranged on the outside of the cavity of the container and include a retention face intended to come into contact with a restraining face positioned on a cylindrical wall extending axially from the wall of the container towards the outside of the container.
The means of restraint are formed by snap-fastening devices comprising a plurality of lugs, including claws on their radially external face, positioned on a wall of the plate of the technical module and extending in the main direction from an external face of the wall towards the outside of the container.
The means of restraint are formed by elements welded onto an external surface of a wall of the plate.
The means of restraint are formed by a plurality of jumpers or by a continuous ring.
The means of restraint are arranged in such a way that, when the module is in place, the plate is able to move in the main direction within the limits of a predetermined free play.
Retention means block the rotation of the plate of the technical module about an axis parallel to the main direction.
The plate of the technical module forms a fluid-tight connection avec the wall of the container.
The fluid-tight connection between the plate of the technical module and the container is formed by an O-ring positioned between a first cylindrical surface having an axis parallel to the main direction and supported by the wall of the container, and a second surface, likewise cylindrical, having an axis parallel to the main direction when the plate is in place, and supported by the plate of the technical module, such that the O-ring is compressed radially between the first cylindrical surface and the second cylindrical surface.
The plate of the technical module comprises at least one technical device selected from among the technical devices:
   a pump,
   a temperature sensor,
   a means of heating,
   a concentration sensor,
   a quality sensor,
   a level sensor,
   a ventilation device.
The overall dimension of the technical devices arranged on the technical module is greater than the passage provided by the opening (50).
Preferably, the container is formed by the assembly of two halves, each of the halves being produced by injection.

The invention will be more readily understood from a perusal of the accompanying figures, which are provided by way of example and are not restrictive in nature, in which:

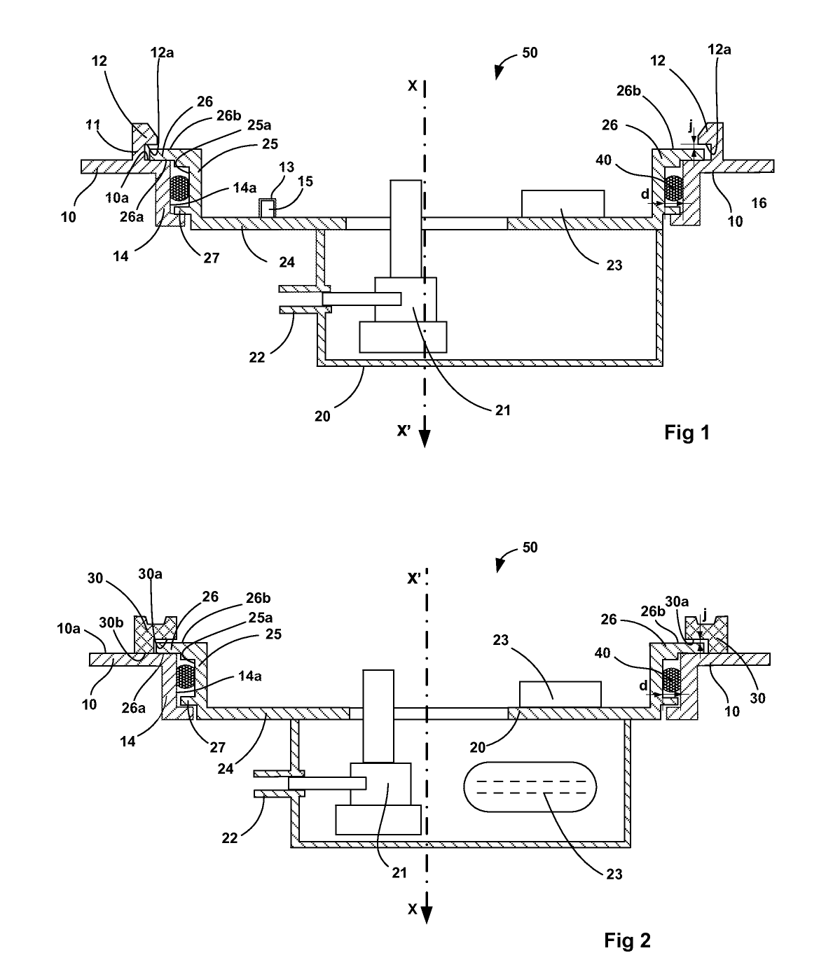

FIGS. 1 and 2 represent a sectional view of a container comprising a module positioned according to a first and a second embodiment of the invention, in which the means of restraint of the plate are situated inside the container.

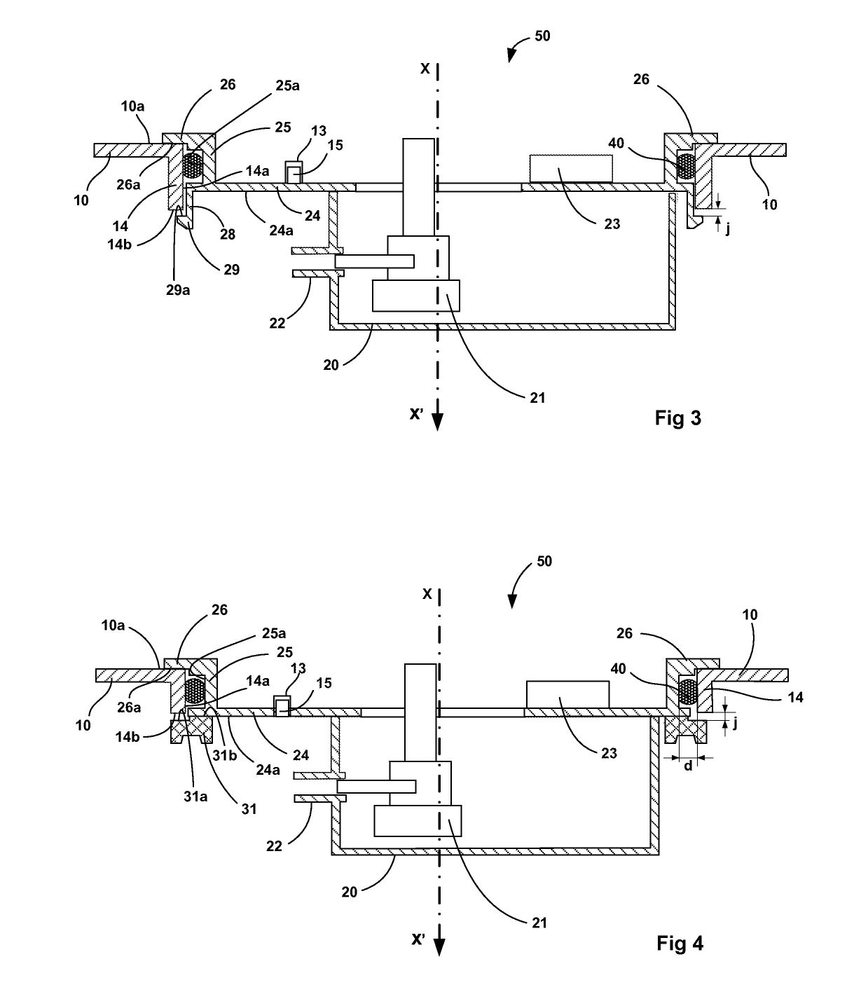

FIGS. 3 and 4 represent a sectional view of a container comprising a module positioned according to a third and a fourth embodiment of the invention, in which the means of restraint of the plate are situated on the outside of the container.

The partial view of the container illustrated in FIG. 1 comprises a wall 10 delimiting an enclosed volume intended to contain a liquid. FIG. 1 represents more specifically the part of the wall including an opening 50. This opening 50 is preferably of substantially circular form, although this form is not restrictive. The axis XX′, which here is locally perpendicular to the plane of the wall, passes substantially through the center of the opening.

The opening 50 is sealed in a fluid-tight manner by a plate 20. This plate 20 comprises a wall 24 forming a base, to which are fixed technical devices such as a pump 21, an outlet pipe 22 and a level detector 23, which are visible in FIG. 1. These technical devices are not restrictive, and the technical module may likewise comprise a temperature sensor, a means of heating, a quality sensor, a concentration sensor, or any other element that can be introduced into the container in order to ensure the control and the transfer of the fluid that it contains.

The plate 20 is introduced into the opening 50 in a main direction, indicated here by the direction of the axis XX′, by a movement from the inside of the container towards the outside of the container.

The technical devices are situated on the side of the internal part of the container. These technical devices may have an overall dimension that is larger or possibly much larger than the passage delimited by the opening 50, due to the fact that it is no longer necessary to make provision for them to pass through the opening 50 in order to arrange them in the internal part of the container.

The elements for the connection of the technical module to the external components communicate with the outside of the container.

The plate includes a flange 26, extending radially towards the outside and positioned on a lateral wall 25 of the plate 20. The flange has an external diameter that is greater than the diameter of the opening 50 such that, when the plate is in place, the bearing surface 26a of the flange abuts against a bearing 10a situated on the internal face of the container. The movement of the plate towards the outside is then blocked.

This bearing 10a is directed towards the inside of the container, that is to say that the normal emerging from the surface 10a is directed towards the inside of the container.

In order to prevent the disengagement of the plate from the opening 50, means of restraint are provided and are formed by snap-on elements comprising lugs 11 positioned on the internal face of the wall 10 of the container and extending towards the inside of the container. A number of teeth 12 are positioned on the radially internal face of the lugs.

During the introduction of the plate 20 into the opening 50 in the direction oriented away from the axis XX′, the flange 26 parts the teeth 12, which reclose once more over the restraining face 26b of the flange 26, in so doing continuing the introduction movement. The displacement of the plate towards the inside of the container is then limited by the contact of the restraining face 26b of the flange 26 with the restraining face 12a of the snap-on claw 12.

The introduction movement of the container into the opening in the main direction is sufficient to be able to engage the snap-on fastening means without being obliged to resort to additional other operations. The technical module is retained in its position of use immediately following its introduction.

It should also be noted that the lug 11 includes only a single tooth 12, but that this number is not limited, and that it is entirely possible to provide a plurality of teeth 12 on the radially internal face of the lug 11, and spaced apart one from the other in the main direction. The multiplication of the number of teeth permits the free play of the plate along the axis XX′ to be adjusted more accurately.

It should also be noted that the plate remains free to move between the bearing 10a of the wall of the container 10 and the internal face 12a of the tooth 12. The free play j, measured between the restraining face 26b of the plate and the restraining face 12a of the tooth, may be adjusted at will by adjusting the length of the lug 11 or the thickness of the flange 26.

Although a single lug carrying a tooth allows the desired technical effect to be achieved, a person skilled in the art will be able to ascertain the number of lugs permitting the satisfactory retention of the plate to be assured by increasing the number of snap-on lugs to three, or even four lugs, distributed in a regular manner around the circumference of the opening 50.

The movements of the plate 20 are also not blocked in radial directions in relation to the main direction XX′. This latter arrangement has proved to be particularly interesting in order to ensure a fluid-tight connection between the plate 20 and the wall 10 of the container.

The wall 10 of the container includes a first cylindrical surface 14a, positioned, in the embodiment being the object of the present description, on a wall 14 forming an axial extension of the wall of the container and substantially delimiting the opening 50. This first cylindrical surface 14a has an axis parallel to the main direction XX′, and its generators are parallel to the axis XX′.

The plate 20 comprises a second cylindrical surface 25a positioned on the radially external face of the wall 25, having an axis that is likewise parallel to the main direction XX′.

Once the plate has been introduced into the opening 50, the first cylindrical surface 14a supported by the wall 10, and the second cylindrical surface 25a supported by the plate, are positioned facing towards one another and separated from one another by a substantially constant distance d.

VVhen the right-hand section of the cylindrical surfaces 14a and 25a is circular, the resulting two circles are then concentric.

An O-ring 40 is positioned between the two cylindrical surfaces 14a and 25a such as to achieve the sealing between the plate and the wall 14. The distance d is then adjusted in order to permit the substantially constant radial squeezing of the O-ring 40 between the two cylindrical surfaces 14a and 25a. In other words, it is the O-ring 40 that regulates the value of the distance d between the two cylindrical surfaces 14a and 25a.

Because of the relative radial mobility of the plate after snapping-on the plate, the self-centering of the plate in relation to the O-ring can take place without difficulty and permits the substantially radial constant squeezing of the O-ring 40 over its entire length. The radial position of the plate is adjusted automatically depending on the position of the O-ring. The sealing between the plate and the container is thus greatly improved, in that the O-ring is not likely to lose contact with one or other of the cylindrical surfaces 14a or 25a around the entire periphery of the opening. The plate 20 then closes the opening 50 completely and prevents any leakage of the liquid contained in the container.

The wall 25 may comprise a return 27 permitting the O-ring 40 to be retained in place.

In order to prevent the rotation of the plate about an axis parallel to the principal axis XX′, the wall 24 forming the base the plate 20 supports fingers 15 oriented axially and capable of being inserted into housings 13 made in the radially internal face of the wall 25. These centring fingers may also act as a foolproofing device.

It should be noted here that the main direction XX′ is not necessarily perpendicular to the plane of the opening and may, by an adaptation of the form of the bearing 10a and lugs 11, locally form an angle with the plane of the wall of the container where the opening 50 is located.

The mounting of the plate in the container is then implemented in a very simple manner by offering up the plate 20 in front of the opening 50, and by introducing it in the direction of introduction XX′, which is coincident with the main direction, after previously having positioned the O-ring 40 around the second cylindrical surface 25a that is supported by the plate. The fingers 15 penetrate into the housings 13.

At the moment of its introduction, the first cylindrical wall 14a slides on the O-ring by squeezing it gently, the effect of which is to center the plate 20 in relation to the opening 50.

Manufacturing of the container takes place preferentially by the injection of a thermoplastic material into a mold including drawer elements, in order to allow the molding of the undercut elements such as the teeth of the snap-fastening means.

The presence of the snap-fastening means allows a rapid assembly of the plate supporting the technical devices on the wall of the container by the simple introduction movement, without being obliged to resort to additional fixing means.

The elements according to the second embodiment represented in FIG. 2 and similar to the elements according to the first embodiment in FIG. 1 are designated by the same numerical indices.

In this second embodiment, the means of restraint permitting the movement of disengagement of the plate from the opening towards the inside of the container to be restricted are formed by internal restraining elements 30 welded directly via a face 30b onto the internal face 10a of the wall 10 of the container. These means of restraint are arranged such that the restraining face 30a may abut against the restraining face 26b of the flange 26 in order to block the extraction movement of the module.

A free play j may be arranged between the restraining face 30a and the restraining face 26b of the flange 26, such as to allow the movement of the plate in the main direction XX′.

The means of restraint 30 may adopt various forms and may exhibit the form of a set of jumpers welded at a plurality of points distributed carefully around the periphery of the internal surface 10a of the container. A set consisting of three jumpers distributed every 120° around the circumference of the opening makes it possible to obtain a satisfactory mechanical effect at a reduced cost. The means of restraint may also take the form of a continuous circular ring welded at points, or for the entire length of its periphery, on the wall 10 of the container.

VVhen the container is molded or injected using a thermoplastic material, it may be preferred to produce the means of restraint in a compatible material. The welding between the faces 10a of the container and 30b of the restraining means may then be realized by automated means of the mirror welding type operating in extremely rapid cycle times.

In the third and the fourth embodiment of the invention, which are illustrated by FIGS. 3 and 4, the restraining elements of the plate are arranged on the outside of the container.

FIG. 3 illustrates the case in which the disengagement of the plate is prevented by snap-on elements comprising a lug 28 extending axially towards the outside from the external surface 24a of the wall 24 forming the base of the plate.

Each lug 28 includes on its extreme part a claw 29, positioned on the radially external face of the lug, and including a restraining surface 29a.

During the introduction of the plate 20 into the opening 50 in the direction oriented away from the axis XX′, the wall 14 parts the teeth 29, which then reclose over the restraining face 14b of the wall 14, in so doing continuing the introduction movement. The displacement of the plate towards the inside of the container is then limited by the contact of the restraining face 14b of the wall 14 with the restraining face 29a of the snap-on claw 29.

This third variant embodiment of the invention, in which the means of restraint are accessible, allows the relative disengagement of the technical module by a simple actuation of the snap-fastening means.

The variant embodiment of the invention illustrated in FIG. 4 proposes to weld the face 31b of a restraining element 31 onto the external face 24a of the wall 24 forming the base of the plate 20.

In these latter two embodiments of the invention, the free play j between the restraining face 14b supported by the wall 14 and the restraining face, respectively 29a and 31a, of the means of restraint, may be adjusted in order to allow the axial displacement of the plate within predetermined limits.

This method of introducing the technical module into the container is particularly suitable when the container is manufactured in two halves or two half shells intended to be assembled one with the other in order to form a closed chamber. This manufacturing technique then allows the use of injection means, of which the industrial performance permits a substantial reduction in the cost of producing the container.

It should also be noted that the size of the opening 50 is no longer necessarily determined by the overall dimension of the technical devices arranged on the technical module, and may have an overall dimension that is larger or possibly much larger than the free space offered by the opening. In other words, by taking into account the projections on a plane perpendicular to the main direction of the technical module and of the opening, regardless of the angular orientation of the projection of the opening in relation to the projection of the technical module, an overlapping zone still exists between the two projections preventing the passage of the module through the opening.

Of course, the invention is not restricted to the embodiments described above, and a person skilled in the art will be easily able, within the general scope of the claims, to identify equivalent arrangements allowing the desired effects to be achieved.

### LIST OF REFERENCE DESIGNATIONS

10 wall of the container.
10a bearing positioned on the internal face of the wall of the container.
11 internal snap-on lug.
12 internal snap-on claw.
12a restraining face of the internal snap-on claw.
13 housing for the centring finger.
14 cylindrical wall positioned on the wall of the container and forming an axial extension around the opening 50.
14a first cylindrical surface.
14b restraining face of the wall 14.
15 centring finger.
20 plate.
21 pump.
22 outlet pipe.
23 level detector.
24 wall forming the base of the plate.
24a external face of the wall 24 forming the base of the plate.
25 lateral cylindrical wall of the plate 20.
25a second cylindrical surface positioned on the radially external surface of the wall 25.
26 flange of the plate.
26a bearing surface of the flange.
26b restraining face of the flange.
27 return allowing the retention of the O-ring in place.
28 external snap-on lug.
29 external snap-on claw.
29a restraining face of the external snap-on claw.
30 internal means of restraint.
30a restraining face of the restraining means abutting against the restraining face 26b of the flange.
30b face of the restraining means welded onto the internal face of the container.
31 external restraining means.
31a restraining face of the external restraining means abutting against the restraining face 14b of the wall 14.
31b face of the external restraining means welded onto the external face 24a of the wall 24 forming the base of the plate.
40 O-ring.
50 opening.
XX′ main direction.
j free play between the restraining face 26b/14b and the restraining face 12a/29a/30a/31a.
d distance between the first cylindrical surface 14a and the second cylindrical surface 25a.

1-15. (canceled)

16. A container comprising:
a wall including an opening sealed by a plate of a technical module including at least one technical device, sealing of the opening resulting from insertion of the plate into the opening in a main direction;
wherein the plate of the technical module includes a flange including a bearing surface; and
wherein the inner wall of the container includes a bearing directed towards inside of the container, which acts as a seat for the flange, to block passage of the plate of the technical module through the opening towards outside of the container.

17. A container according to claim 16, further comprising means for restraint to prevent the plate from becoming disengaged from the opening, while at a same time allowing the plate to move radially in relation to the main direction.

18. A container according to claim 17, wherein the means for restraint is arranged inside a cavity of the container and includes a restraining face configured to be brought into engagement with a restraining face of the flange opposite the bearing surface.

19. A container according to claim 18, wherein the means for restraint includes snap-fastening devices including a plurality of lugs, including claws on their radially internal face positioned on the wall of the container and extending in the main direction from the internal face of the wall of the container towards inside of the container.

20. A container according to claim 18, wherein the means for restraint includes welded elements on the internal face of the wall of the container.

21. A container according to claim 17, wherein the means for restraint is arranged on an outside of the cavity of the container and includes a retention face configured to come into contact with a restraining face positioned on a cylindrical wall extending axially from the wall of the container towards the outside of the container.

22. A container according to claim 21, wherein the means for restraint includes snap-fastening devices including a plurality of lugs, including claws, on their radially external face positioned on a wall of the plate of the technical module and extending in the main direction, from an external face of the wall towards outside of the container.

23. A container according to claim 21, wherein the means for restraint includes elements welded onto an external surface of a wall of the plate.

24. A container according to claim 20, wherein the means for restraint includes a plurality of jumpers or a continuous ring.

25. A container according to claim 17, wherein the means for restraint is configured such that, when the module is in place, the plate is configured to move in the main direction within limits of a predetermined free play.

26. A container according to claim 16, further comprising retention means to block rotation of the plate of the technical module about an axis parallel to the main direction.

27. A container according to claim 16, further comprising an O-ring to form a fluid-tight connection between the plate of the technical module and the container, the O-ring being positioned between a first cylindrical surface having an axis parallel to the main direction and supported by the wall of the container, and a second surface, also cylindrical, having an axis parallel to the main direction when the plate is in place and supported by the plate of the technical module, such that the O-ring is compressed radially between the first cylindrical surface and the second cylindrical surface.

28. A container according to claim 16, wherein the plate of the technical module comprises at least one technical device selected from among the following technical devices:
a pump,
a temperature sensor,
a means for heating,
a concentration sensor,
a quality sensor,
a level sensor,
a ventilation device.

29. A container according to claim 16, wherein an overall dimension of the technical devices arranged on the technical module is greater than the passage provided by the opening.

30. A container according to claim 16, formed by assembly of two halves, each of the halves being produced by injection.
